(19) United States
(12) Patent Application Publication
(10) Pub. No.: US 2010/0049793 A1
(43) Pub. Date: Feb. 25, 2010

(54) DYNAMIC VIDEO PRESENTATION BASED UPON RESULTS OF ONLINE ASSESSMENT

(76) Inventor: MICHAEL BOERNER, Eagle, ID (US)

Correspondence Address: DYKAS, SHAVER & NIPPER, LLP, P.O. BOX 877, BOISE, ID, 83701-0877, US

(21) Appl. No.: 12/547,212

(22) Filed: Aug. 25, 2009

Related U.S. Application Data
(60) Provisional application No. 61/091,672, filed on Aug. 25, 2008.

(51) Int. Cl. G06F 3/01; G06F 15/16

(52) U.S. Cl. 709/203; 715/716; 715/760

(57) ABSTRACT

A method of providing a dynamic video presentation based upon results of an online assessment, the presentation, including content and order, specifically chosen to coach, train and/or counsel the individual who take the online assessment.

### PRIORITY/CROSS-REFERENCE TO RELATED APPLICATIONS

This application claims the priority date of the provisional application entitled Dynamic Video Presentation Based Upon Results of Online Assessment filed by Michael Boerner, on Aug. 25, 2008 with application Ser. No. 61/091,672, the disclosure of which is incorporated herein by reference.

### BACKGROUND

“DISC” is a four quadrant behavioral model based on the work of William Moulton Marston Ph.D. (1893-1947) to examine the behavior of individuals in their environment or within a specific situation (otherwise known as environment). It therefore focuses on the styles and preferences of such behavior. DISC assessments classify four aspects of behavior by testing a person's preferences in word associations. DISC is an acronym for: Dominance—relating to control, power and assertiveness; Influence—relating to social situations and communication; Steadiness (submission in Marston's time)—relating to patience, persistence, and thoughtfulness; and Conscientiousness (or caution, compliance in Marston's time)—relating to structure and organization. Source: Wikipedia on “DISC assessment” (as of Jul. 24, 2009, 20:52 GMT). One version of the DISC assessment is referred to as the Target Training International (TTI) DISC test instrument.

### BRIEF DESCRIPTION OF THE DRAWINGS

FIG. 1 is a flow chart of a method according to a preferred embodiment of the invention.

FIG. 2 is a block diagram of an exemplary computer system.

FIG. 3 is a block diagram of a system according to a preferred embodiment of the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted. The term “client-server network” refers to a network where one or more servers are coupled to one or more clients over a communications channel, unless otherwise noted. The terms “computer system,” “computer,” “client computer,” and “server computer,” as used herein, include but are not limited to a personal computer system, a work station computer system, a lap top computer system, a “netbook” computer system, an embedded controller system, a microprocessor-based system, a digital signal processor-based system, a hand held device system, a personal digital assistant (PDA) system, a cell phone, a wireless system, a wireless networking system, and an Internet capable device, unless otherwise noted. The term “coach” means a professional (e.g., counselors, pastors) that provides real time coaching of an individual, unless otherwise noted.

The present invention is a method of providing a dynamic video presentation based upon results of an online assessment taken by an Individual, where the presentation, including content and order, specifically chosen to coach, train and/or counsel the Individual.

In the preferred embodiment, the online assessment taken by the Individual looks at a combination of multiple factors, specifically, the measured scores and their correlated ranges as returned by the by the test administration instrument, as interpreted by the various analyzers that utilize the same four key scored parameters. The preferred test administration instrument is the TTI DISC test instrument. Other test administration instruments with business algorithms could also be utilized for multiple applications in business, medical, educational, and others.

In the TTI DISC test instrument, these four parameters, labeled “D,” “I,” “S,” and “C,” are represented by a numerical score with a whole value between 0 and 100. The resulting scores are categorized into one of 3 groups or score ranges for each parameter: High (60-100), Mid-Range (40-59), and Low (0-39). This results in a total of 12 different individual groupings, as listed in Table 1.

TABLE 1

| | | |
|---|---|---|
| High D | Mid-Range D | Low D |
| High I | Mid-Range I | Low I |
| High S | Mid-Range S | Low S |
| High C | Mid-Range C | Low C |

The Individual tested will receive a score for each parameter (D, I, S, C), and as these scores are input into the training system, either manually or automatically from the testing server. The scoring creates a profile for the Individual based on how those scores fit into the above categories. For example: Individual A is assessed as having scores of D=24, I=48, S=72, C=16 would be profiled for training as having a: “Low D, Mid Range I, High S, Low C” personality type user profile.

Based upon the assessed personality type user profile determined by the assessment, a “Personalized Play List” of video content pertinent to that specific personality type user profile is then created. For the above example, the Personalized Play List for Individual A would be based upon his/her scores of “Low D, Mid Range I, High S, Low C.”

The Personalized Play List's video content can be selected from a video library containing multiple independent video segments. For instance, a predetermined quantity of “Low D” video segments may be present for playing in any order, or in a preferred order, to a person assessed as having “Low D” scores. More preferably, the video segments would be played in a predetermined order, the order selected so as to collectively recreate the typical individual training session that an individual would receive in a live coaching environment (e.g., counseling, marriage counseling, personal coaching).

Determination of the selection of the video content and/or the order of the video content is preferably made through careful review and analysis of “live” training sessions where a coach (or other professional, including but not limited to counselors, pastors, etc.) provides real time coaching of an individual, paying specific attention to the flow of the coaching (later used to create the segmentation of the videos). Additionally, the coaching could be modified or become specific in the presence of empirical data (e.g., scores, input, yes/no answers). Performing such a real time analysis will allow for the creation of an outline and/or flowchart/decision tree that will assist in the determination of an appropriate video flow, while facilitating the logic (i.e., if yes, then play video x; if no, then play video y) that creates the customized and dynamic training environment. Following this analysis of a live presentation, the outline for video production can be created whereby the coach can be filmed providing a version of each segment, beginning and ending specific portions of the training to coincide with the logic flow and outline that has been defined.

It is preferred that each variable parameter of the dynamic components be filmed independently, broken down to a point where it can stand complete and independent of any other video. These “variable” videos become the dynamic component of the training, and for the most simplistic example, would contain two videos for a “yes/no” variable, the first addressing a “yes” response, and the second addressing a “no” response.

It is further preferred that the video content be organized into multiple parts or segments. For instance, the organization and sequential display of video content could utilize a three-part outline of: (1) Introduction and Foundation (Static); (2) Specific Parameter Training (Dynamic); and (3) Score Interactions and Summary (Dynamic).

Under the Introduction and Foundation (Static) part, the video content would be selected to help the assessed Individual review his/her profile; contain general statements about the assessed Individual's personality and/or results; would cover profile accuracy and provide tips regarding how the Individual communicates and how to (and how not to) communicate effectively with the Individual, contains an action play and styles analysis graphs.

Under the Specific Parameter Training (Dynamic component) part, the video content selected would consist of the twelve parameter groupings listed above (Table 1) and the four parameter grouping videos that are most pertinent for the specific person and profile presented (in the example above, the “Low D” video, the “Mid Range I” video, the “High S” video, and the “Low C” video).

Under the Score Interactions and Summary (Dynamic) part, video content would be selected covering combining dimensions, natural vs. adapted styles, mapping the Individual's comfort zone, success insights wheel, and a conclusion.

In a preferred embodiment, the Personalized Play List would contain a total of thirteen independent videos selected from a library of twenty-one total videos. In this embodiment, the unselected videos represent the eight videos for each of the eight less pertinent (to the assessed Individual) parameter groupings listed above (Table 1), reduced to the four that are pertinent for the specific person and profile presented.

If, either during or following their personalized video training session, the assessed Individual wishes to see the videos that were not selected for their specific score (e.g., if they wish to see the videos that pertain to a spouse), they can select to “view all,” and the remaining unselected videos will be added to their play list for viewing.

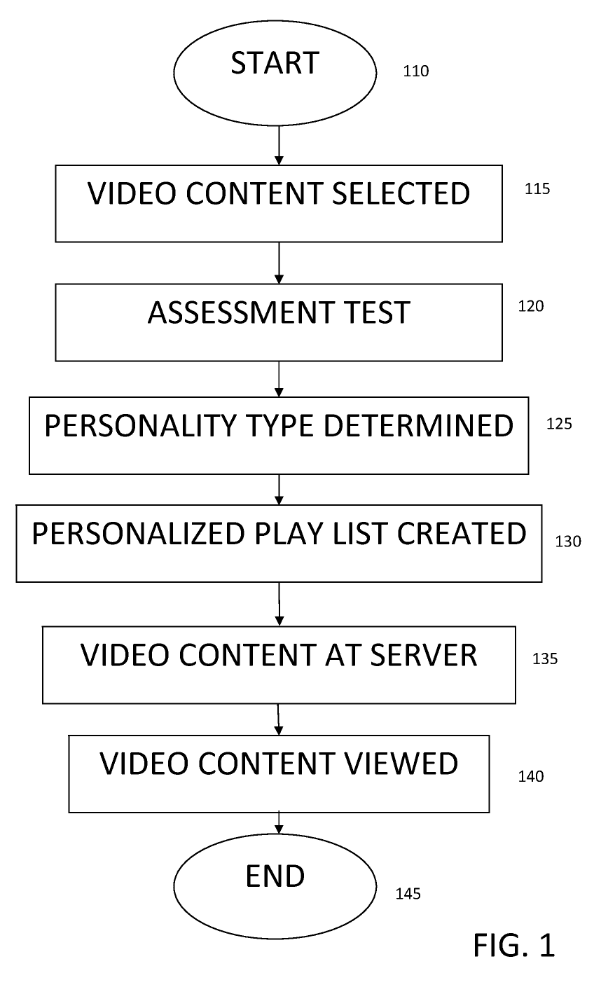

The flow chart of FIG. 1 illustrates the dynamic video presentation architecture showing the interaction of the various subsystems according one preferred embodiment of the invention. In such an architecture, at least one client computer and at least one server computer are coupled together in the typical manner.

The process begins at step 110.

At step 115, a Coach selects a plurality of video content items able to be displayed on a computer screen or other display to an Individual based upon the Individual's personality type user profile determined by the results of a personality test taken by the Individual. The video content preferably stored on a storage device coupled to the client-server computer network.

At step 120 an Individual uses a test administration instrument to take an assessment test, preferably using a client computer having a software user interface, generating a set of results. The assessment test analyzing the Individual's personality.

At step 125, the Individual's assessment test results are used to determine a personality type user profile for the Individual.

At step 130, a Personalized Play List from said video content is created for the Individual based upon his/her personality type user profile based upon the previous selection by a Coach of which video content items are associated with which personality type user profile(s).

At step 135, the Personal Play List video content is received either by a server computer or in some other way by a provider of such content for display to said Individual. The method thereby resulting in the generation of a request to the server computer to create a new web page containing said video content. The server computer publishing said video content selections on said new web page for viewing by said Individual.

At step 140, the Individual may use a second client computer system, preferably having a software user interface connected there-to, to interact with the server computer via a communications network such as the Internet or a Local Area Network (LAN) to access the Personal Play List video content. This may involve filling in a form on a web page and sending the form to the server via a hypertext protocol operation such as a ‘post’ or ‘get’ operation, or it may involve sending an electronic mail message, or may involve communicating by any other suitable protocol.

At step 145, the process ends.

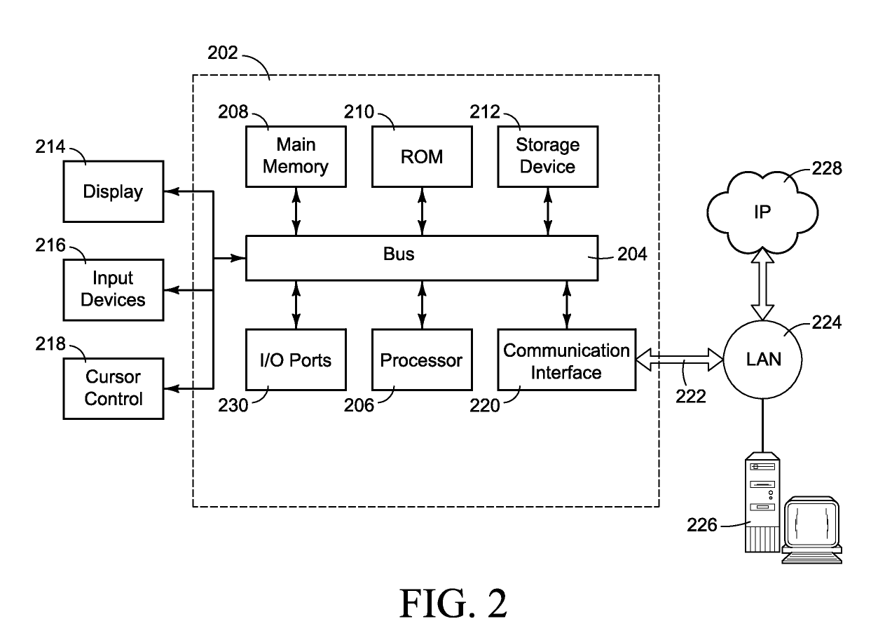

FIG. 2 illustrates a “computer system” 202 upon which the present invention may be implemented. The computer system 202 includes a bus 204 or other communication mechanism for communicating information and a processor 206 coupled with bus 204 for processing the information. The computer system 202 also includes a main memory 208, such as a random access memory (RAM) or other dynamic storage device (e.g., dynamic RAM (DRAM), static RAM (SRAM), synchronous DRAM (SDRAM), flash RAM), coupled to bus 204 for storing information and instructions to be executed by processor 206. In addition, main memory 208 may be used for storing temporary variables or other intermediate information during execution of instructions to be executed by processor 206. Computer system 202 further includes a read only memory (ROM) 210 or other static storage device (e.g., programmable ROM (PROM), erasable PROM (EPROM), and electrically erasable PROM (EEPROM)) coupled to bus 204 for storing static information and instructions for processor 206. A storage device 212, such as a magnetic disk or optical disk, is provided and coupled to bus 204 for storing information and instructions.

The computer system 202 also includes input/output ports 230 to couple the computer system 202 to external devices. Such coupling may include direct electrical connections, wireless connections, networked connections, etc., for implementing automatic control functions, remote control functions, etc.

The computer system 202 may also include special purpose logic devices (e.g., application specific integrated circuits (ASICs)) or configurable logic devices (e.g., generic array of logic (GAL) or re-programmable field programmable gate arrays (FPGAs)). Other removable media devices (e.g., a compact disc, a tape, and a removable magneto-optical media) or fixed, high-density media drives, may be added to the computer system 202 using an appropriate device bus (e.g., a small computer system interface (SCSI) bus, an enhanced integrated device electronics (IDE) bus, or an ultra-direct memory access (DMA) bus). The computer system 202 may additionally include a compact disc reader, a compact disc reader-writer unit, or a compact disc jukebox, each of which may be connected to the same device bus or another device bus.

The computer system 202 may be coupled via bus 204 to a display 214, such as a cathode ray tube (CRT), liquid crystal display (LCD), voice synthesis hardware and/or software, etc., for displaying and/or providing information to a computer user. The display 214 may be controlled by a display or graphics card. The computer system includes input devices, such as a keyboard 216 and a cursor control 218, for communicating information and command selections to processor 206. Such command selections can be implemented via voice recognition hardware and/or software functioning as the input devices 216. The keyboard 216 may be a touch screen display. The cursor control 218, for example, is a mouse, a trackball, cursor direction keys, touch screen display, optical character recognition hardware and/or software, etc., for communicating direction information and command selections to processor 206 and for controlling cursor movement on the display 214. In addition, a printer may provide printed listings of the data structures, information, etc., or any other data stored and/or generated by the computer system 202.

The computer system 202 performs a portion or all of the processing steps of the invention in response to processor 206 executing one or more sequences of one or more instructions contained in a memory, such as the main memory 208. Such instructions may be read into the main memory 208 from another computer readable medium, such as storage device 212. One or more processors in a multi-processing arrangement may also be employed to execute the sequences of instructions contained in main memory 208. In alternative embodiments, hard-wired circuitry may be used in place of or in combination with software instructions. Thus, embodiments are not limited to any specific combination of hardware circuitry and software.

As stated above, the system 202 includes at least one computer readable medium or memory programmed according to the teachings of the invention and for containing data structures, tables, records, or other data described herein. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling the computer system 202, for driving a device or devices for implementing the invention, and for enabling the computer system 202 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium that participates in providing instructions to processor 206 for execution. A computer readable medium may take many forms, including but not limited to, non-volatile media, volatile media, and transmission media. Non-volatile media includes, for example, optical, magnetic disks, and magneto-optical disks, such as storage device 212. Volatile media includes dynamic memory, such as main memory 208. Transmission media includes coaxial cables, copper wire and fiber optics, including the wires that comprise bus 204. Transmission media also may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 206 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to computer system 202 may receive the data on the telephone line and use an infrared transmitter to convert the data to an infrared signal. An infrared detector coupled to bus 204 can receive the data carried in the infrared signal and place the data on bus 204. The bus 204 carries the data to main memory 208, from which processor 206 retrieves and executes the instructions. The instructions received by main memory 208 may optionally be stored on storage device 212 either before or after execution by processor 206.

The computer system 202 also includes a communication interface 220 coupled to bus 204. Communication interface 220 provides a two-way data communication coupling to a network link 222 that may be connected to, for example, a local network 224. For example, communication interface 220 may be a network interface card to attach to any packet switched local area network (LAN). As another example, communication interface 220 may be an asymmetrical digital subscriber line (ADSL) card, an integrated services digital network (ISDN) card or a modem to provide a data communication connection to a corresponding type of telephone line. Wireless links may also be implemented via the communication interface 220. In any such implementation, communication interface 220 sends and receives electrical, electromagnetic or optical signals that carry digital data streams representing various types of information.

Network link 222 typically provides data communication through one or more networks to other data devices. For example, network link 222 may provide a connection to a computer 226 through local network 224 (e.g., a LAN) or through equipment operated by a service provider, which provides communication services through a communications network 228. In preferred embodiments, local network 224 and communications network 228 preferably use electrical, electromagnetic, or optical signals that carry digital data streams. The signals through the various networks and the signals on network link 222 and through communication interface 220, which carry the digital data to and from computer system 202, are exemplary forms of carrier waves transporting the information. The computer system 202 can transmit notifications and receive data, including program code, through the network(s), network link 222 and communication interface 220.

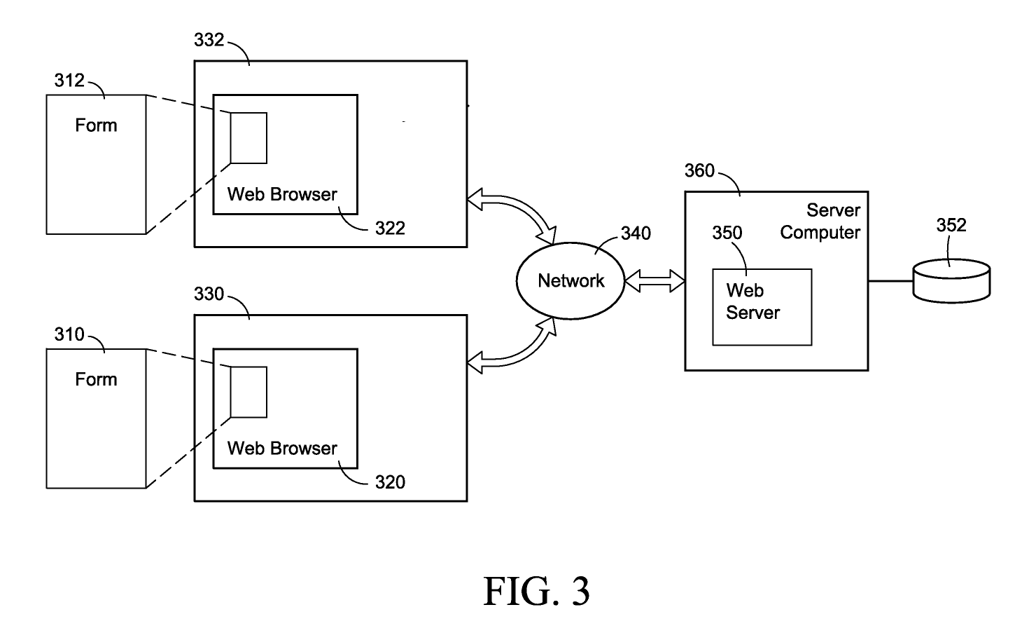

FIG. 3 shows a block diagram of a system according to a preferred embodiment of the invention. The Figure showing a computer implemented dynamic video presentation system for use by a Coach in coaching an Individual, the system (in this embodiment) including a Coach's client computer 332, an Individual's client computer 330, and a server computer 360, all connected together via a network 340 (e.g., the Internet, a local area network (LAN)). Each of the client computers 330, 332 and the server computer 360 may incorporate the elements of the computer systems as described in relation to FIG. 2.

The Coach provides a source of video content based upon possible personality types of the Individual. A content repository 352, connected to the client-server network, stores this video content.

The Server Computer 360 serves content from the content repository 352 to a Individual's client computer (or other knowledge access client, e.g., software, web page, client computer, cell phone, Internet connected device).

A Coach can, for instance through a connected client computer, such as the Coach's client computer 332, search the content repository 352 via the server computer 360, and select content from the content repository 352 to be transmitted to an Individual based upon the Individual's personality test results, thereby creating a Personalized Play List(s).

As described in FIG. 1, the Coach's content selection might be entered into or selected via a form 312 on a web browser 322 on the Coach's client computer 332. This information communicated via the network 340 to a web server program 350 running on the server computer 360.

The Individual would then take a personality test via a request form 310 in a web browser 320 on the Individual's client computer 330, the test results communicated via the network 340 to the web server program 350 running on the server computer 360. Based upon the test results, the server computer 360 determines the personality type user profile of the Individual. The server computer 360, via the web server program 350, then communicates video content (the Personalized Play List) to the Individual's client computer 330 for display to the Individual.

The protocols that may be used have been discussed previously. The method as shown in FIG. 1 may then take place either as a series of steps in a stored program run on the server computer or on another computer, and any or all portions of this method may instead be performed manually.

The disclosed invention may take a number of forms, including to but not limited to the following examples and combinations of elements of said examples.

While the preferred embodiment utilizes an online assessment and online video display, this same methodology could be applied to any live training process where, in a live training environment, the curriculum or topics covered are dynamically modified in the course of the training based on empirical feedback or data provided by either the training environment or the trainee themselves, whether through a response instrument such as an assessment, or through verbal feedback, survey, or discussion.

One Example Embodiment. A computer-implemented method of providing a dynamic video presentation based upon results of an online assessment taken by an individual, said computer-implemented method comprising the steps of: defining a plurality of different personality types; storing a plurality of video content items on a storage device coupled to a computer; associating one or more of said video content items with each of said personality types; testing, using a computer, an individual via a test administration instrument to determine said individual's personality type; creating, using a computer, a video content play list of video content items associated with the individual's personality type for said individual; and displaying, using a computer, said video content play list to said individual. Optionally, said displaying step further comprises the steps of: generating a request to a server computer to create a new web page containing said video content items designated in said video content play list; and publishing said video content items on said new web page for viewing by said individual. Optionally, the computer in said storing step is a server computer; the computer in said testing step is a client computer system having a software user interface connected there-to configured to interact with said server computer via a communications network to access said video content play list; and the computer in said step of creating, using a computer, a video content play list for said individual based upon the video content items associated with the individual's personality type is said server computer, wherein said individual uses a second client computer system, preferably having a software user interface connected there-to, to interact with said server computer via a communications network such as the Internet or a Local Area Network (LAN) to access the Personal Play List video content.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the claimed invention will become readily apparent to those skilled in this art from this detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A computer-implemented method of providing a dynamic video presentation based upon results of an online assessment taken by an individual, said computer-implemented method comprising the steps of:
defining a plurality of different personality types;
storing a plurality of video content items on a storage device coupled to a computer;
associating one or more of said video content items with each of said personality types;
testing, using a computer, an individual via a test administration instrument to determine said individual's personality type;
creating, using a computer, a video content play list of video content items associated with the individual's personality type for said individual; and
displaying, using a computer, said video content play list to said individual.

2. The computer-implemented method of claim 1, wherein said displaying step further comprises the steps of:
generating a request to a server computer to create a new web page containing said video content items designated in said video content play list; and
publishing said video content items on said new web page for viewing by said individual.

3. The computer-implemented method of claim 1, wherein the computer in said storing step is a server computer.

4. The computer-implemented method of claim 3, wherein the computer in said testing step is a client computer system having a software user interface connected there-to configured to interact with said server computer via a communications network to access said video content play list.

5. The computer-implemented method of claim 3, wherein the computer in said step of creating, using a computer, a video content play list for said individual based upon the video content items associated with the individual's personality type is said server computer.

6. The computer-implemented method of claim 5, wherein said individual uses a second client computer system, preferably having a software user interface connected there-to, to interact with said server computer via a communications network such as the Internet or a Local Area Network (LAN) to access the Personal Play List video content.
